(19) United States
(12) Patent Application Publication
(10) Pub. No.: US 2014/0020300 A1
(43) Pub. Date: Jan. 23, 2014

(54) DEVICE FOR COVERING AN ACTUATING ELEMENT, EMERGENCY ACTUATING DEVICE, AND A METHOD FOR SECURING A PANE

(71) Applicants: Thomas Höller, Ferschnitz (AT); Lukasz Kita, Krakow (PL); Andreas Tazreiter, Waidhofen a.d. Ybbs (AT)

(72) Inventors: Thomas Höller, Ferschnitz (AT); Lukasz Kita, Krakow (PL); Andreas Tazreiter, Waidhofen a.d. Ybbs (AT)

(73) Assignee: KNORR-BREMSE GMBH, Modling (AT)

(21) Appl. No.: 14/009,154

(22) PCT Filed: Apr. 4, 2012
(86) PCT No.: PCT/EP2012/056145

§ 371 Date: Oct. 1, 2013

(30) Foreign Application Priority Data
Apr. 7, 2011 (DE) 102011016297.6

(51) Int. Cl. G05G 5/00

(52) U.S. Cl. CPC G05G 5/005
USPC 49/394

(57) ABSTRACT

A device for covering an actuating element having a pane for covering the actuating element and a frame for receiving the pane, the frame has an inner opening and a guideway for guiding the pane from a covering position into an access position. In the covering position, the pane closes the inner opening. In the access position, the pane at least partially exposes the inner opening to allow an operator to have access to the actuating element through the inner opening. In addition, the device has a retainer element which is designed to hold the pane in the covering position when a force acting on the retainer element via the pane is smaller than a release force. Furthermore, the retainer element is designed to allow the pane to move into the access position when a force acting on the retainer element via the pane is greater than the release force.

### PRIORITY CLAIM

This patent application is a U.S. National Phase of International Patent Application No. PCT/EP2012/056145, filed 4 Apr. 2012, which claims priority to German Patent Application No. 10 2011 016 297.6, filed 7 Apr. 2011, the disclosures of which are incorporated herein by reference in their entirety.

### FIELD

Disclosed embodiments relate to an apparatus for covering an actuation element, to an emergency actuation device, for example, for actuation of a door or a brake of a vehicle by a passenger in the event of an emergency, and to a method for securing a pane in an apparatus for covering an actuation element.

An emergency actuation device is used, for example, in a rail vehicle, in order to enable a passenger to open a door of the rail vehicle in the event of an emergency. The emergency actuation device has a protective glass as a cover. In order to be able to operate the emergency actuation device, it is necessary to break the protective glass.

### SUMMARY

Disclosed embodiments provide an improved apparatus for covering an actuation element, an improved emergency actuation device and an improved method for securing a pane.

### BRIEF DESCRIPTION OF THE FIGURES

Disclosed embodiments are explained in greater detail below with reference to the appended drawings, in which:

FIG. 1 is a front view of an emergency actuation unit;

FIG. 2 is a partial view of an emergency actuation unit;

FIG. 3 is a sectioned view of an emergency actuation unit;

FIG. 4 is another sectioned view of an emergency actuation unit;

FIG. 5 is another sectioned view of an emergency actuation unit; and

FIG. 6 is a view of an apparatus for covering an actuation element.

### DETAILED DESCRIPTION

The notion of the disclosed embodiemtns is that it is not absolutely necessary to break a covering pane of the emergency actuation device in order to actuate the emergency actuation device. Instead, the covering pane can be moved in order to afford access to an actuation element of the emergency actuation device. To this end, the emergency actuation device may have a component which fixes the covering pane in a covering position until an activating event takes place. In accordance with the activating event, the component may release the covering pane, whereby the covering pane can move out of the covering position. The activating event may be an impact or generally an application of pressure on the pane.

After the emergency actuation device has been actuated, it can be reproduced in a cost-effective manner since it is not necessary to replace the covering pane. Instead, it is simply necessary to move the component for fixing the covering pane into position again.

Disclosed embodiments provide an apparatus for covering an actuation element, having the following features:

a pane for covering the actuation element;

a frame for receiving the pane, the frame having an inner opening and a guide for guiding a movement of the pane from a covering position into an access position, the pane closing the inner opening in the covering position and at least partially releasing the inner opening in the access position in order to allow an operator to access the actuation element through the inner opening; and

a retention element, which is constructed to retain the pane in the covering position when a force acting on the retention element via the pane is smaller than an activating force and which is constructed to release the movement of the pane into the access position when a force acting on the retention element via the pane is greater than the activating force.

The actuation element may be part of an emergency actuation device. Such an emergency actuation device may be used, for example, in rail traffic, in order to allow a person to independently unlock a door of a rail vehicle or to initiate an emergency braking operation of the rail vehicle. To this end, the emergency actuation device may be arranged in an inner space of the rail vehicle or on a platform.

Alternatively, the emergency actuation device may be provided for any other applications, for example, for activating a fire alarm. The apparatus may also be used in order to cover an emergency key or the like. In this instance, the actuation element may be the emergency key.

Alternatively, the actuation element may be a lever, a switch or the like. The pane may, for example, comprise glass or plastics material and in particular acrylic glass. The pane may be constructed so as to be unbreakable in the sense that it remains intact when a person strikes the pane in order to actuate the operating element. The pane may be at least partially transparent so that the operating element can be seen by a person through the pane. The frame may be produced from metal or plastics material. The frame may be composed of a plurality of individual components. The frame may be constructed in a plate-like manner with a substantially centrally arranged through-opening as an inner opening. The inner opening may be completely surrounded by the frame.

A contour of the inner opening may be adapted to a contour of the pane, the pane being able to be larger than the inner opening. Accordingly, a width of the pane may be greater than a width of the inner opening. A length of the pane may also be greater than a length of the inner opening. For example, the inner opening and the pane may be rectangular. The guide may be formed by one or more edge faces of the frame and additionally or alternatively by one or more guiding elements which are connected to the frame. For example, edges of the pane which is located in the covering position may engage in frame grooves or pockets which adjoin the inner opening. Corresponding grooves or pockets may be part of the guide.

On the one hand, the pane can consequently be held in the covering position by the guide. In the covering position, the pane closes the inner opening either completely or to such an extent that an actuation of the actuation element by a person is prevented. In the assembled state of the apparatus, the movement of the pane into the access position, brought about by gravitational force, can be carried out in a downward direction.

Alternatively, for example, a resilient element may be provided, by which the pane can be moved into the access position, in this instance in any direction. In the access position, the pane either releases the inner opening completely or closes it only partially so that a person can actuate the operating element. The actuation may, for example, be carried out by a person reaching through the inner opening with his hand. In order to access the operating element, it may be necessary for the person to press or strike the pane in order to transmit to the retention element via a pane a force which is greater than the activating force. As a result of the force, the pane is pressed in the direction of the operating element.

As long as the force is smaller than the activating force, the retention element may prevent or limit an inward movement of the pane in the direction of the operating element to such an extent that the pane is retained in the covering position. If the force exceeds the activating force, the retention element is either deformed or displaced and consequently enables a sufficiently large inward movement of the pane, in order to release the pane from the covering position.

When the retention element is arranged in the lower region of the pane, the movement of the pane inwards can be carried out only by the lower region of the pane, and the pane can consequently carry out a tilting movement inwards in order to be released from the covering position. After the pane has been released from the covering position, the pane does not continue to be fixed by the guide so that the pane can carry out the movement into the access position.

The retention element may be of metal or plastics material. The retention element may be formed by a portion of the frame of the guide or by a separate component. If the retention element is a separate component, it may be connected to the frame in a rigid manner so that it can be bent by the acting force or can break. Alternatively, the retention element may be movably connected to the frame in the direction of the acting force so that the retention element can be displaced by the acting force.

According to one embodiment, the guide may have a guiding element having a retention face and a sliding face. The retention face may be constructed to retain an edge region of the pane which is located in the covering position. The sliding face may be constructed to enable the pane to slide along the sliding face when the pane is moved into the access position. If the pane is located in the covering position, the pane and the guiding element may be located in one plane. An edge of the pane may be supported on or be in abutment with the support face. Main extension planes of the support face and the sliding face may be inclined relative to each other. The support face and the sliding face may merge into each other in a flowing manner. The sliding face may be orientated parallel or in an inclined manner relative to the movement direction of the pane into the access position.

The support face may be orientated transversely or in an inclined manner relative to the movement direction of the pane into the access position. The retention element may prevent the pane from sliding off the support face. Owing to the guiding element, the pane may, on the one hand, be stabilized in the covering position and, on the other hand, be guided into the access position.

The frame may have a discharge opening. The guide may further be constructed in order to guide at least one edge region of the pane out of the frame through the discharge opening when the pane is moved into the access position. The discharge opening may be arranged laterally on the frame, for example, at the bottom. The discharge opening may be a slot. By means of the guide, the edge region of the pane can be guided to the discharge opening. The pane, when it has reached the access position, can be retained from completely passing the discharge opening by a suitable retention device. In this manner, the pane remains connected to the frame and does not become lost. Alternatively, the pane could completely pass the discharge opening. The discharge opening enables the movement of the pane into the access position not to be limited by the dimensions of the frame.

Furthermore, the guide may have a recess in the region of the retention element in order to receive at least a portion of the retention element when the force acting on the retention element is greater than the activating force. Consequently, at least the portion of the retention element which is located in order to retain the pane in a movement path of the pane from the covering position into the access position can be moved from the movement path and into the recess. In this manner, jamming or blocking of the pane during movement into the access position can be prevented. If the retention element is broken, a broken portion of the retention element may also be received and secured by the recess.

The retention element may have a desired breaking location. Along the desired breaking location, the retention element may break or bend when the force acting on the retention element is greater than the activating force. As a result of the desired breaking location, an actuation behavior of the retention element can be predetermined in a simple manner.

According to one embodiment, the apparatus may have a securing element by means of which the retention element is secured to the frame in a replaceable manner. The term “replaceable” may mean that the retention element can be removed from the frame without damaging the retention element, the frame or the securing element. For example, the retention element may be secured to the frame by means of one or more screw connections. The retention element can thereby be replaced in a simple and cost-effective manner.

The pane may have in an edge region at least one resilient element, by means of which the pane is connected to the frame both in the covering position and in the access position. The resilient element may be of rubber, for example, of cellular rubber. The resilient element may be adhesively bonded to the pane. It may, for example, be a strip whose longitudinal extent direction extends transversely to the movement direction of the pane into the access position. If the pane is located in the covering position, a main surface of the resilient element facing away from the pane may abut a surface of the frame in a planar manner. The resilient element may thereby act as an impact absorber. When the pane is located in the access position, a side face of the resilient element may be in abutment against a projection of the frame facing the pane. For example, the side face of the resilient element may abut the retention face of the guiding element. In this manner, the pane can be retained in the access position by the resilient element. A resilient element may be provided at each side of the pane.

The pane may be constructed so as to be opaque in two opposing end regions and transparent in a central region arranged between the two opposing edge regions. The opaque regions may be constructed in a strip-like or bar-like manner. The transparent region enables a person to see the actuation element through the pane. However, the opaque regions may prevent other elements which are not intended to be visible to the person from being seen. By opposing edge regions being constructed in an opaque manner, the other elements can be concealed by the pane both in the covering position and in the access position. The opaque regions may also be provided with indications for the person.

According to one embodiment, the frame may have a front frame element and a rear frame element, which can be connected to each other by means of a hinge. The pane may be arranged inside the front frame element. The guiding element and the retention element may be arranged on the front frame element. Both the front and the rear frame elements may have a layered structure, for example, comprising a plurality of sheets. In the folded-open state, the retention element can be replaced. As an alternative to a hinge, other connection means may be provided. The hinge has the advantage that the frame elements are further connected in the folded-open state.

Disclosed embodiments further provide an emergency actuation device, having the following features:

an actuation element for actuating the emergency actuation device;

a housing, in which the actuation element is arranged, the housing having an opening; and

an apparatus for covering an actuation element according to one of the preceding embodiments, the frame of the apparatus being secured to the housing and the inner opening of the frame being located in the region of the opening of the housing in order to afford an operator access to the actuation element when the pane is located in the access position.

The emergency actuation device may be formed as a case which may, for example, be secured to a wall. The housing may be produced from metal or plastics material. The housing may have a base and a wall. The wall may be constructed in a continuous manner. The wall may surround the opening of the housing. Consequently, the housing may be in the form of a tub. The frame may rest on the wall of the housing and may consequently form a lid for the housing. The actuation element may have a mechanical or electrical interface by means of which information relating to actuation of the actuation element can be transmitted. A mechanical or electrical component which is connected to the interface may be guided through the wall. To this end, the wall may have a recess.

Disclosed embodiments further provide for a method for securing a pane in an apparatus for covering an actuation element according to an embodiment, the method comprising the following operations:

moving the retention element of the apparatus into a retention position for retaining the pane in the covering position; and

securing the retention element to the frame of the apparatus.

The method can be configured in order to move the pane after actuation of the apparatus from the access position back into the covering position. In this instance, it may be necessary to provide the apparatus with a new retention element. The pane may be returned from the access position to the covering position through the discharge opening. In order to introduce the pane into the guide, it may be necessary to disassemble the unit if it is not possible to introduce the pane through the discharge opening of the unit, for example, owing to cellular foam strips.

In the following description, identical or similar reference numerals are used for the elements which are illustrated in the various drawings and which function in a similar manner, with a repeated description of these elements being omitted.

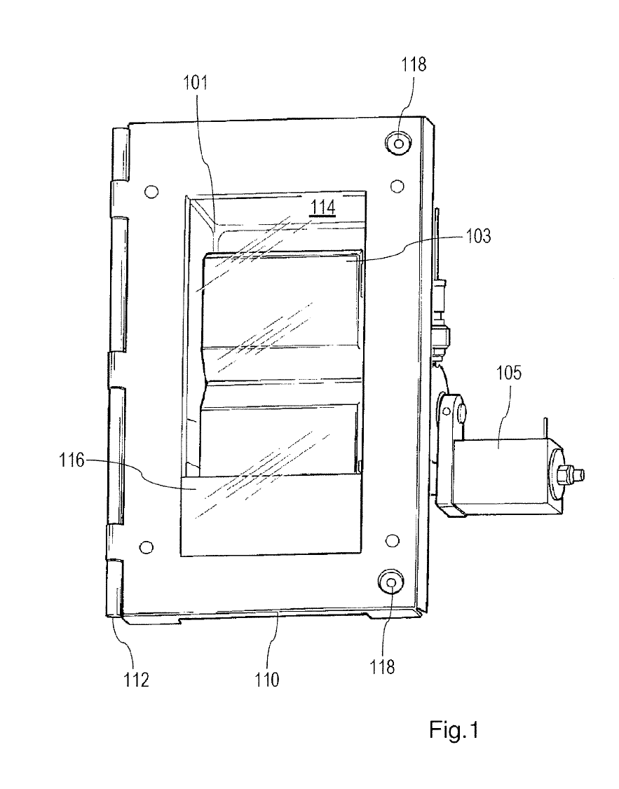

FIG. 1 shows an emergency actuation unit having an apparatus for covering an actuation element in the form of a protective glass cover, according to an embodiment.

The emergency actuation unit has a housing 101 in which an actuation element in the form of a lever 103 is arranged. The housing 101 is bowl-like so that the housing 101 has an opening at a front side opposite the base of the housing 101. The lever 103 is thereby visible from the front side of the emergency actuation unit. A wall of the housing 101 extends beyond the lever 103 so that the lever 103 is completely received by an inner space of the housing 101. A free end of the lever 103 forms a handle and is so far away from an upper wall portion of the housing 101 shown at the top in FIG. 1 that a person can grip the free end of the lever 103 with a hand and can actuate the lever 103 by pulling on the free end. By the lever 103 being actuated, the lever 103 carries out a pivot movement which is transmitted to an element 105 of the emergency actuation unit located outside the housing 101.

The apparatus for covering an actuation element closes the housing 101 at the front side. The apparatus is plate-like and forms a cover for the housing 101 in the assembled state. The apparatus has a frame which is secured to the wall of the housing 101. A front cover 110 of the frame is shown in FIG. 1. The frame has a front frame element and a rear frame element which are connected to each other by means of a hinge 112. The hinge 112 extends along a longitudinal side of the frame. The frame is rectangular and has a rectangular aperture. The aperture has a greater length than width. A width of the aperture is greater than a width of the lever 103. A length of the aperture is also greater than a length of the lever 103.

The lever 103 is arranged substantially centrally with respect to the aperture. Consequently, the front cover 110 and the lever 103 do not overlap each other. The frame has a pane 114 which closes the aperture of the frame. The pane 114 is guided within the frame. The region of the pane 114 located within the aperture is transparent with the exception of a lower edge region 116. Consequently, the lever 103 can be seen through the pane 114. The lower edge region 116 is opaque over the entire width of the aperture as far as a lower edge of the aperture. A transition between the transparent region and the opaque region of the pane 114 is constructed in a linear manner. A mechanical arrangement between the lever 103 and the element 105 of the emergency actuation unit is covered by the opaque region 116. The frame has two through-holes 118 via which the frame can be secured to the housing 101.

In the illustration shown in FIG. 1, the pane 114 is in a covering position in which the aperture of the frame is completely closed by the pane 114. In order to actuate the lever 103, the pane 114 must be moved from the covering position into an access position in which the aperture, at least in an access region on the lever 103, is no longer closed by the pane 114.

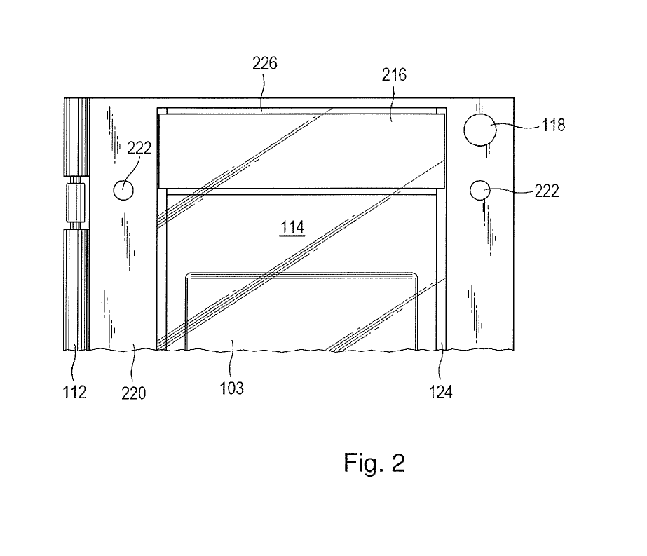

FIG. 2 shows a portion of the emergency actuation unit shown in FIG. 1. An upper portion of the emergency actuation unit is shown, without the cover 110 shown in FIG. 1. The pane has in an upper edge portion another opaque region 216. If the pane 114 is located in the covering position, the other opaque region 216 is arranged below the cover. A front frame plate 220 shown in FIG. 2 is further located below the cover. The front frame plate 220 has an aperture corresponding to the cover. In this instance, the aperture of the front frame plate 220 is greater than the aperture of the cover so that the front frame plate 220 is completely concealed by the cover. The aperture of the front frame plate 220 has a greater width and a greater length than the pane 114.

The front frame plate 220 has in addition to the through-hole 118 additional through-holes, through which a front guiding plate 222 of the frame can be seen. The front guiding plate 222 has an aperture corresponding to the front frame plate 220, the aperture of the front guiding plate 222 being of the same size or greater than the aperture of the front frame plate 220 so that the front guiding plate 222 is concealed by the front frame plate 220.

A rear guiding plate 224 of the frame can further be seen. The rear guiding plate 224 has an aperture corresponding to the front frame plate 220, the aperture of the rear guiding plate 224 having a smaller width than the aperture of the front frame plate 220 so that lateral edge regions of the rear guiding plate 224 extend into the aperture of the front frame plate 220.

It is further possible to see a rear frame plate 226 of the frame. The rear frame plate 226 has an aperture corresponding to the front frame plate 220, the aperture of the rear frame plate 226 having a smaller length than the aperture of the front frame plate 220 so that at least an upper edge region of the rear guiding plate 224 extends into the aperture of the front frame plate 220.

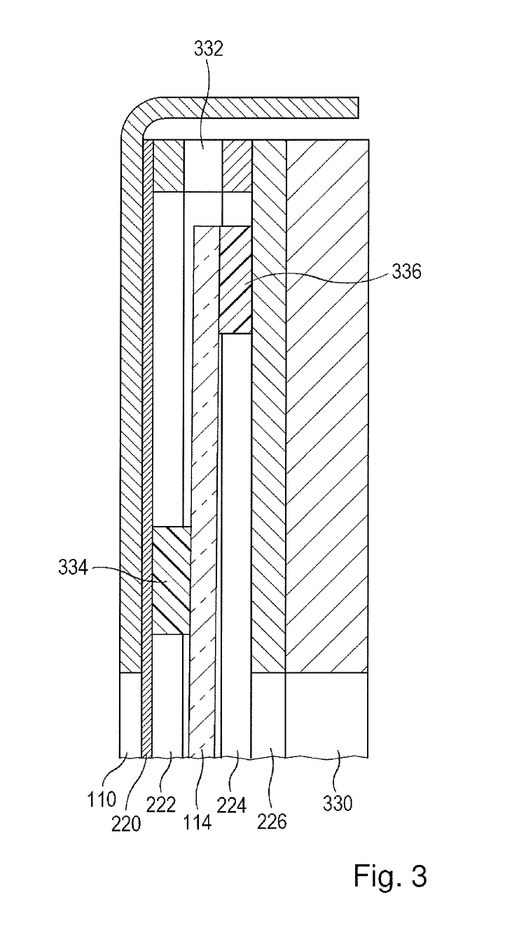

FIG. 3 shows a portion of the apparatus shown in FIG. 1 for covering an actuation element, according to an embodiment. A sectioned illustration through an upper portion of the apparatus is shown. The emergency actuation unit has a layered structure. From left to right, the cover 110, the front frame plate 220, the front guiding plate 222, the rear guiding plate 224, the rear frame plate 226 and a securing plate 330 are shown. A free space 332 in which the pane 114 is arranged is between the front guiding plate 222 and the rear guiding plate 224.

A resilient element 334, 336 is arranged at opposing surfaces of the pane 114, respectively. The resilient elements 334, 336 are arranged within the printed region 216 shown in FIG. 2. The resilient elements 334, 336 extend over an entire width of the pane 114. The resilient element 334 extends over a thickness of the front guiding plate 222 and is in abutment against the front frame plate 220. The resilient element 336 extends over a thickness of the rear guiding plate 224 and is in abutment against the rear frame plate 226. The pane 114 is arranged in an oblique manner inside the free space 332 so that an upper end of the pane 114 shown in FIG. 3 abuts the rear guiding plate 224 and a lower end of the pane 114 not shown in FIG. 3 abuts the front guiding plate 222. The front frame plate 220, the front guiding plate 222, the rear guiding plate 224 and the rear frame plate 226 form the free space 332 as a pocket guide for the pane 114. In this instance, the free space 332 is greater than a thickness of the pane 114 so that the pane 114 can move within the free space 332.

An edge region of the cover 110 has a bend and extends over the upper ends (shown in FIG. 3) of the front frame plate 220, the front guiding plate 222, the rear guiding plate 224, the rear frame plate 226 and the securing plate 330. Consequently the cover 110, in addition to a front cover, also forms a lateral cover of the frame.

The cover 110, the front frame plate 220, the front guiding plate 222, the rear guiding plate 224, the rear frame plate 226 and the securing plate 330 may be constructed as metal sheets. The front frame element which comprises the cover 110, the front frame plate 220 and the front guiding plate 220 may alternatively also be constructed in one piece or be constructed from additional elements. Accordingly, the front frame element which comprises the rear guiding plate 224, the rear frame plate 226 and the securing plate 330 may alternatively also be constructed in one piece or from additional elements.

The securing plate 330 may be constructed as a securing metal sheet. The securing plate 330 may be placed on the housing of the emergency actuation unit and be secured to the housing.

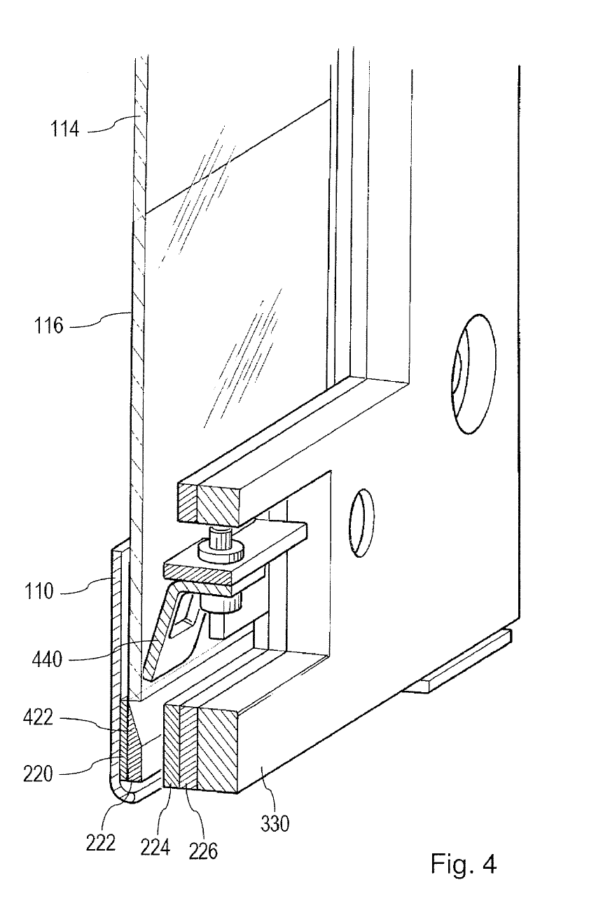

FIG. 4 shows a portion of the apparatus shown in FIG. 1 for covering an actuation element according to an embodiment. A sectioned illustration through a lower and central portion of the apparatus is shown. Part-portions of the cover 110, the front frame plate 220, the front guiding plate 222, the pane 114, the rear guiding plate 224, the rear frame plate 226 and the securing plate 330 are shown. It can be seen that the elements 110, 220, 222, 224, 226, 330 form an aperture over which the pane 114 extends. The illustration shown in FIG. 4 is a longitudinal section which extends in a longitudinal direction along a centre line of the pane 114. A lower, non-transparent region 116 of the pane 114 extends as far as a lower edge of the pane.

The pane 114 rests with the lower edge thereof on a guiding element 422 which is formed by a lower portion of the front guiding plate 222. The guiding element 422 has an inclined portion at the side facing the rear guiding plate 224. The inclined portion tapers in an acute manner. The pane 114 consequently rests on an acute longitudinal edge of the front guiding plate 222. The acute longitudinal edge consequently forms a retention face for the pane 114. The lower portion of the front guiding plate 222 and an opposing region of the rear guiding plate 224 are spaced apart from each other and form a portion of a free space for moving the pane 114. Consequently, the inclined portion of the guiding element 440 forms a sliding face for the pane 114.

The apparatus has a retention element 440. The retention element 440 is secured to the rear guiding plate 224. The retention element 440 is constructed so as to retain the pane 114 in a covering position in which the pane 114 rests on the guiding element 422. The retention element 440 is constructed as an elongate element, for example, a flap, which, starting from the rear guiding plate 224, extends in an inclined manner in the direction of the pane 114 and touches the pane 114 with a free end. In this instance, the retention element 440 extends downwards in an inclined manner. In order to secure the retention element 440, the rear guiding plate 224 has an angled region which extends through another recess of the rear frame plate 226 and the securing plate 330. The retention element 440 may be secured to the angled region by means of a screw connection. To this end, the retention element 440 may have an elongate hole which extends in the longitudinal direction of the retention element 440. The elongate hole may serve to bring the retention element 440 into position during assembly.

If the pane 114 is pressed against the retention element 440 by means of application of pressure, the retention element 440 may break or bend. The free end of the retention element 440 is thereby pressed towards the rear guiding plate 224 and can be received by the additional recess of the rear frame plate 226 and the securing plate 330. The inclined portion of the guiding element 422 results in the pane 114 sliding along the inclined portion, in this instance in a downward direction, after or during the movement of the free end of the retention element 440. The pane 114 consequently first carries out, at least with the region in abutment with the guiding element 422, a movement perpendicularly relative to the main extent plane of the pane 114, in this instance backwards, and subsequently a movement transversely relative to the main extent plane of the pane 114, in this instance downwards.

The cover 110 is guided around the lower ends of the front frame plate 220, the front guiding plate 222, the rear guiding plate 224, the rear frame plate 226 and the securing plate 330. In this instance, however, the cover 110 has a free space within a central region in which the pane 114 is arranged. Consequently, the free space of the cover 110 continues the free space which is formed between the front guiding plate 222 and the rear guiding plate 224. The pane 114 may move, during a movement into the access position between the lower portions of the front guiding plate 222 and the rear guiding plate 224, through to the free space of the cover 110 and through the free space of the cover 110.

Such a movement of the pane 114 can be ended by one of the resilient elements of the pane 114 being positioned on the guiding element 422 and the other resilient element of the pane 114 being positioned on an end region of the rear guiding plate 224. Such an edge region of the rear guiding plate 224 may be arranged at both sides of the angled region of the rear guiding plate 224.

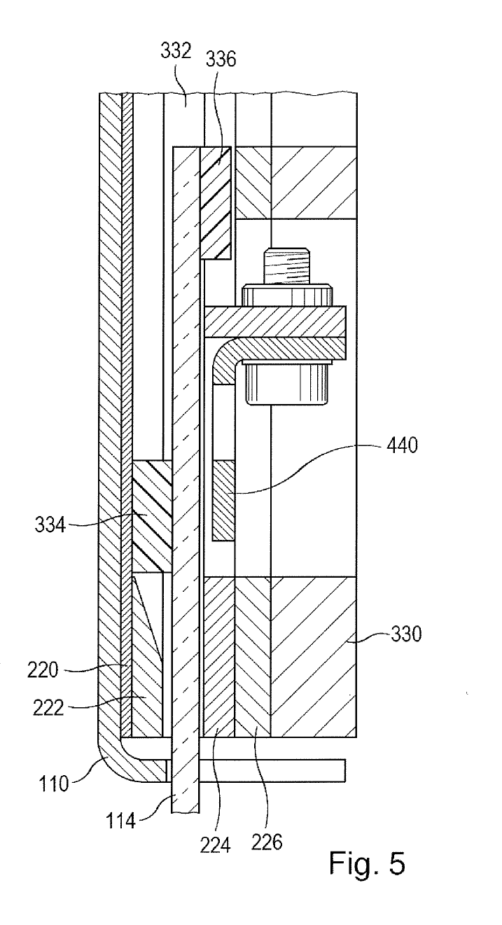

FIG. 5 is a sectioned illustration through a lower portion of the apparatus shown in FIG. 4 for covering an actuation element according to an embodiment . The cover 110, the front frame plate 220, the front guiding plate 222, the pane 114, the rear guiding plate 224, the rear frame plate 226, the securing plate 330 and the retention element 440 are shown.

In contrast to FIG. 4, the retention element 440 in FIG. 4 has a greater curvature at a curved edge. A free end of the retention element 440 extends parallel or almost parallel with a main extent direction of the rear guiding plate 224. In this manner, the pane 114 is not impeded by the retention element 440 during a movement out of the covering position shown in FIG. 4 into an access position. The free end of the retention element 440 has been moved into the position shown in FIG. 5 by means of a pressure applied via the pane 114. The retention element 440 may thereby have been deformed in a non-reversible manner.

The upper portion of the pane 114 with the resilient elements 334, 336 at both sides is shown. A lower portion and a central portion of the pane 114 extend from the lower free space of the cover 110. The front resilient element 334 rests on the guiding element 422 and the rear resilient element 336 on an edge region of the rear guiding plate 224.

In the illustration shown in FIG. 5, the pane 114 is located in the access position in which the aperture, at least in an access region to the lever 103 shown in FIG. 1, is no longer closed by the pane 114.

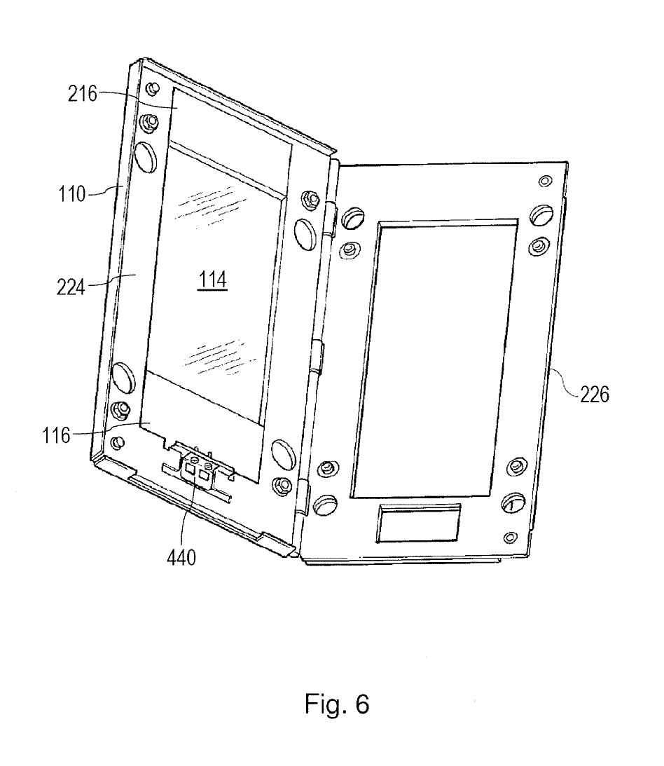

FIG. 6 shows the apparatus shown in FIG. 1 for covering an actuation element according to an embodiment. The apparatus is shown in a state folded open. The front frame element with the cover 110, the pane 114 and the rear guiding plate 224 with the retention element 440 can be seen. The opaque regions 116, 216 of the pane 114 are shown. Furthermore, the rear frame element with the rear frame plate 226 and the securing plate can be seen. The front frame element and the rear frame element are connected to each other by means of the hinge 112. The rear frame element has, below the aperture for the pane 114, the other recess for receiving the retention element 440.

In order to move the pane 114 back into the access position in the event of completed actuation of the emergency actuation unit, the apparatus, as illustrated in FIG. 6, can be folded open. Subsequently, the pane 114 can be moved through the lower free space of the cover 110 back into the frame until the pane 114 assumes the position shown in FIG. 6. To that end, for example, the pane 114 can be pushed upwards until it strikes an upper stop of the frame. The retention element 440 can further be replaced by the securing action of the deformed old retention element 440 being released, the old retention element 440 being removed and a new retention element 440 being introduced. In order to position the retention element 440, it can be moved in the direction of the pane 114, pressed with the free end against the pane 114 and retained in this retention position. As a result of the positioning of the retention element 440, the pane 114 is moved into the covering position if the pane 114 has not already assumed the covering position. Whilst the retention element 440 is located in the retention position, the retention element 440 can be securely fixed to the rear guiding plate by means of the securing action. The operations described of folding open the frame, moving the pane 114 and replacing the retention element 440 can also be carried out in a sequence different from that described.

With reference to FIGS. 1 to 6, as a further embodiment, a protective glass covering for an inner emergency actuation unit in a foldable embodiment is described below. The inner emergency actuation unit is provided for a vehicle for conveying people.

To this end, FIG. 1 is a front view of an emergency actuation unit having a protective glass covering. As shown in FIG. 1, a protective glass unit is placed on an emergency actuation unit and covers it completely. The actuation lever 103 of the emergency actuation unit 105 itself is covered only by a thin acrylic glass pane 114. The acrylic glass pane 114 is printed on the outer side so that only the actuation lever 103 of the emergency actuation unit is visible to the passenger. In addition, in this printed region 116, instructions for the passenger can still be applied in a signaling color.

As shown in FIG. 2, the protective glass 114 itself is located within the unit, guided in a pocket and retained in position by various components. The lateral guiding is carried out by a pocket-like recess of the housing 110, 220, 222, 224, 226, 330. As a result of the pocket-like recess, the protective glass 114 is guided into the desired position after being struck. A corresponding pocket guide of the protective glass 114 is shown in FIG. 2 in a view without the cover 110.

As shown in FIG. 3, the protective glass 114 is retained in position in the upper region of the unit by means of two cellular rubber strips 334, 336, one at the front edge and one at the rear edge, respectively. These act at the same time as impact absorbers and absorb vibrations during travel operation. Corresponding to this, an upper guide of the protective glass pane 114 is shown in FIG. 3 as a side view as a section through the centre.

As shown in FIG. 4, the protective glass pane 114 is stabilized in the lower region of the unit. The stabilization prevents undesirable self-actuation and substantially comprises a support face 422 for fixing in a vertical direction and a breaking flap 440 having a desired breaking location which prevents the protective glass 114 from leaving the support face 422. A corresponding stabilization in the lower region is illustrated in FIG. 4 as an oblique view from the rear and a cross-section through the centre.

When the protective glass 114 is struck, the breaking flap 440 breaks at the desired breaking location, whereby the pane 114 is no longer fixed in position. As a result of the impact pulse, the protective glass 114 leaves the support face 422 and slides downwards inside the pocket guide. During this sliding movement, the protective glass 114 is not influenced by the breaking flap 440, since it disappears in a free space which is provided therefor or can fall away backwards when the flap is torn from the base member in an undesirable manner. The stabilization of the protective glass pane 114 during the falling movement is ensured laterally by the pocket guide and perpendicularly relative thereto by the two cellular rubber strips 334, 336. These strips 334, 336 also prevent the protective glass 114 from being able to fall downwards and potentially breaking on the floor. This is ensured in that both the support face 422 which has previously held the protective glass 114 in position and an additionally provided stop face act as an end stop for the cellular rubber strips 334, 336 and consequently stop the movement of the protective glass pane 114.

The embodiments described are selected merely by way of example and can be combined with each other. Even if a movement of the pane 114 downwards into the access position is described by way of example with reference to the Figures, the movement of the pane 114 can also be carried out in other directions if, for example, appropriate pressing or tensile elements are provided. In this instance, an arrangement and orientation of the guiding and retention elements described is adapted accordingly.

### LIST OF REFERENCE NUMERALS

101 Housing
103 Lever
110 Cover
112 Hinge
114 Pane
116 Opaque region
118 Through-hole
216 Opaque region
220 Front frame plate
222 Front guiding plate
224 Rear guiding plate
226 Rear frame plate
330 Securing plate
332 Free space
334 Resilient element
336 Resilient element
422 Guiding element
440 Retention element

1. An apparatus for covering an actuation element, the apparatus comprising:
a pane covering the actuation element;
a frame receiving the pane, wherein the frame has an inner opening and a guide guiding a movement of the pane from a covering position into an access position, wherein the pane closes the inner opening in the covering position and at least partially releases the inner opening in the access position in order to allow an operator to access the actuation element through the inner opening; and
a retention element constructed to retain the pane in the covering position when a force acting on the retention element via the pane is smaller than an activating force and which is constructed to release the movement of the pane into the access position when a force acting on the retention element via the pane is greater than the activating force.

2. The apparatus of claim 1, wherein the guide includes a guiding element having a retention face and a sliding face, wherein the retention face is constructed to retain an edge region of the pane located in the covering position and the sliding face is constructed to enable the pane to slide past the retention face and along the sliding face when the pane is moved into the access position.

3. The apparatus of claim 1, wherein the frame has a discharge opening and wherein the guide is constructed to guide at least one edge region of the pane out of the frame through the discharge opening when the pane is moved into the access position.

4. The apparatus of claim 1, wherein the guide has a recess in the region of the retention element to receive at least a portion of the retention element when the force acting on the retention element is greater than the activating force.

5. The apparatus of claim 1, wherein the retention element has a desired breaking location, along which the retention elements breaks when the force acting on the retention element is greater than the activating force.

6. The apparatus of claim 1, further comprising a securing element which secures the retention element to the frame in a replaceable manner.

7. The apparatus of claim 1, wherein the pane has, in an edge region, at least one resilient element which connects the pane to the frame both in the covering position and in the access position.

8. The apparatus of claim 1, wherein the pane is constructed so as to be opaque in two opposing end regions and transparent in a central region arranged between the two opposing edge regions.

9. An emergency actuation device, comprising:
an actuation element actuating the emergency actuation device;
a housing in which the actuation element is arranged, wherein the housing has an opening; and
an apparatus of claim 1, wherein the frame of the apparatus is secured to the housing and the inner opening of the frame is located in the region of the opening of the housing to afford an operator access to the actuation element when the pane is located in the access position.

10. A method for securing a pane in an apparatus for covering an actuation element including a pane covering the actuation element, a frame receiving the pane, wherein the frame has an inner opening and a guide—guiding a movement of the pane from a covering position into an access position, wherein the pane closes the inner opening in the covering position and at least partially releases the inner opening in the access position in order to allow an operator to access the actuation element through the inner opening, and a retention element constructed to retain the pane in the covering position when a force acting on the retention element via the pane is smaller than an activating force and which is constructed to release the movement of the pane into the access position when a force acting on the retention element via the pane is greater than the activating force, wherein the method comprises:
moving the retention element of the apparatus into a retention position for retaining the pane in the covering position; and
securing the retention element to the frame of the apparatus.
